(19) United States
(12) Patent Application Publication
(10) Pub. No.: US 2003/0217525 A1
(43) Pub. Date: Nov. 27, 2003

(54) Installation kit for irregularly shaped window

(76) Inventor: Gary Keith, Augusta, ME (US)

Correspondence Address: BOHAN, MATHERS & ASSOCIATES, LLC, PO BOX 17707, PORTLAND, ME, 04112-8707, US

(21) Appl. No.: 10/152,755

(22) Filed: May 22, 2002

(51) Int. Cl. E06B 1/04; E04B 1/38; E04C 5/00

(52) U.S. Cl. 52/710

(57) ABSTRACT

A stud-support frame for quick and easy installation of a window, particularly of a non-rectangular window, such as an oval, octagonal, or circular window. The stud-support frame has a shape and size that corresponds to that of the window. The frame is typically used together with a template that serves as a guide for cutting a window opening of a specific shape and size in a studded wall construction for receiving the stud-support frame and the window casing of the window. After the window opening is cut, the stud-support frame is inserted into the opening, fastened to the wall studs, and the window casing inserted into the frame. A finishing window trim is assembled around the window casing and covers the face of the stud-support frame that is on the face of the wall, thereby eliminating finish work on the wall around the window.

### BACKGROUND INFORMATION

1. Field of the Invention

The invention relates to the field of window installation. More particularly, this invention relates to the installation of a non-rectangular shaped window in a wall constructed of sheet rock and studs.

2. Description of the Prior Art

When constructing a structure or remodeling a finished structure, wall panels are often cut to create an opening for a window. Ideally the shape and size of the opening in the panel is large enough to accept a window casing, yet small enough that little or no finish work is required after the window is installed. Unless the window is very small and is placed in the wall between wall studs, a section has to be removed from each stud that extends through the space required for the window. The challenge when installing a window according to conventional methods is, then, to cut an opening through the wall panel that is sized somewhat larger than the size of the window casing, to remove a section from the one or more studs that would normally extend through the opening, and then, to frame up the opening so that support is again provided between the upper and lower remaining sections of the studs that were cut and the size of the opening is now sized to just receive the window casing of the window to be installed.

Today, many decorative windows are of unusual shape, such as hexagonal, oval, octagonal, triangular shape, etc. With conventional rectangular windows it is already a challenge to precisely match the size and shape of the opening cut in the wall with that of the window casing that is inserted. With these decorative shapes, the job is even harder to accomplish accurately. A number of attempts have been made over the years to solve this problem. Most of these attempts include adjustable template devices for cutting and framing openings for doors and windows. The main disadvantage of most templates is that each one is adaptable to serve as a template for a variety of sizes and shapes of window and door openings and, as a result, the template can be quite complicated to use.

In housing construction today, unskilled workers may be assisting a sheet rock installer, and, ideally, clear specific instructions and easy-to-use tools that require little or no interpretation in the proper use of the tool are to be provided for the workers. Also, many do-it-yourselfers go to a home supply store and buy windows for retrofitting an already finished wall. The windows come with instructions on how to fit them into the wall, but, if the window is an unusual shape, the homeowner may lack the skill required to properly measure and cut an accurately sized opening through the sheet rock and the wall studs. With some shapes, particularly with oval shapes, it is also very difficult to reconstruct the framing in the wall to replace the studs that were cut to make room for the window. An oval cut will require that the pieces of wood be carefully measured and angled to create the oval opening and provide the support needed in the wall. In the end, the installation of such a window may entail significant time and effort, making it a costly undertaking.

The U.S. patent application Ser. No. 09/867,075, filed on May 29, 2001, and Ser. No. 10/012,837, filed on Dec. 10, 2001, teach the use of a window template that serves as a guide for cutting an opening in a stud wall for the installation of a window of a shape other than simply rectangular. These patent application are commonly owned by the inventor of the present application and are incorporated herein by reference. The templates come in various sizes and shapes, such as oval, circular, hexagonal, octagonal, trapezoidal, etc. The difficulty of framing the opening around the studs still remains. For example, it is very time consuming, even for a person well-skilled in the art of installing windows, to frame up an oval-shaped opening in the studs to receive an oval window.

What is needed, therefore, is a means for easily and quickly framing up an opening in a stud wall to receive a window casing of a non-rectangularly shaped window. What is further needed is such a means that corresponds in size and shape to a template that serves as a guide for cutting a window opening to install a specific size and shape of window. What is yet further needed is a window installation kit that includes template-and-frame set for cutting and framing a window opening for a window.

### BRIEF SUMMARY OF THE INVENTION

For the reasons cited above, it is an object of the present invention to rovide a stud-support frame for easily and quickly framing up an opening in a stud wall to receive a window casing of a non-rectangularly shaped window. It is a further object to provide such a stud-support frame that corresponds in size and shape to a template that serves as a guide for cutting a window opening to install a specific size and shape of window. It is a yet further object to provide a window installation kit that includes a template-and-frame set for guiding the cutting of and the framing up of openings for a plurality of window sizes and/or shapes.

The objects are achieved by providing a prefabricated stud-support frame that corresponds in size and shape to a particular window template and, further, by providing a template-and-frame set that includes a corresponding template and stud-support frame. The opening in the wall is made by cutting through the wall panel and the wall studs, using the outer perimeter of the template as a guide. The prefabricated stud-support frame that corresponds in size and shape to that of the particular template used as a guide is then inserted in the window opening.

As described in the above-cited U.S. patent applications, the template is a flat shape, made of plastic, sheet metal, or other suitably stiff and form-rigid material. The template has an outer perimeter and an inner perimeter, the distance between the two perimeters corresponding to the thickness of the stud that typically needs to be replaced when cutting an opening that necessitates cutting through the wall studs. The inner perimeter of the template is ideally very slightly larger than the outer perimeter of the window casing to be installed to allow for shimming to level the window, if necessary.

The stud-support frame according to the present invention is a prefabricated support frame that fits into the opening in the wall that has been cut with the template as a guide. Essentially, the prefabricated support frame has substantially the same size and shape of the template, seen from a frontal view, but has a depth or a thickness that is substantially the same as that of the entire wall thickness, i.e., the frame depth is approximately equal to the thickness of the wall studs, the internal wall (drywall) and the external wall (plywood). Thus, the inner perimeter of the prefabricated support frame is sized just large enough to receive the window casing of the window to be installed, ideally leaving excess just enough space around the casing to level the window, if necessary.

The outer perimeter of the support frame is approximately the same or slightly smaller than that of the outer perimeter of the template to allow room for shimming the frame to a level position. If the stud thickness is 1½″, and the support frame is constructed of a material that requires approximately the same thickness to provide the necessary support, then the width of the frame and of the template, i.e., the difference between the inner and outer perimeter, is also 1½″. If the support frame is constructed of a material that has greater strength properties and, thus, does not have to be as thick as the studs, then the width of the frame and of the template can be less than 1½″, whereby the size of the inner perimeter is defined by the size of the window casing, and the outer perimeter of the frame can be a distance less than 1½″ from the inner perimeter. Such material includes metals and composite or sandwich materials. An advantage of using composite materials is that the width of the support frame is then smaller and it is easier obtain a finished wall around the window because the standard size finished trim will completely cover the outer perimeter of the window opening cut in the wall, thereby reducing or even eliminating finish work on the wall around the window frame.

[note: frames min. 1½″ in thickness, may vary slightly. Frames may be wider than the dimensional 2×4 (planed down) to 4½ thickness of dry wall and thickness of outside of plywood (½″). This eliminates need for filler strip.] Frame may be slightly larger than outside window casing, see video. Trim may have to be a bit wider. Trim not provided when window is bought. ½″ wider trim. Can use jig saw, doesn't have to be a special router bit.]

The support frame according to the invention and the template enable quick, easy installation of a window and eliminate almost entirely the tedious task of taking precise measurements for properly aligning and installing windows of irregular shape. When installing a window in a wall that is under construction, once the desired location of the window is determined, the studs are cut along the outer perimeter of the template. The support frame that corresponds to the template is then inserted into the opening between the cut studs and fastened to the studs. So, for example, if the window to be installed is oval-shaped, an oval template is used to cut through the wall and studs and then the corresponding oval support frame inserted into the opening to provide the necessary support for the wall studs and to receive the window casing of the window to be installed. After the window casing is inserted into the framed window opening, the trim provided with the window product is fitted around the window on the wall, thereby covering the support frame.

The support frame is made of any suitable material that provides the strength and rigidity required to support the wall studs. Thus, the frames can be prefabricated from wood, plastic material such as polyurethane, or a composite material that includes lightweight, inexpensive material strengthened by a sandwich construction that includes a core of honeycomb or corrugated material.

### BRIEF DESCRIPTION OF THE DRAWINGS

FIG. 1A shows a frontal view of the support frame according to the present invention for installing an octagonal window.

FIG. 1B shows a side view of the support frame of FIG. 1A.

FIG. 2 is a frontal view of a template according to the invention for installing an octagonal window.

FIG. 3 is a frontal view of a template according to the invention for installing a round window.

FIG. 4 is a perspective view of a template according to the invention for installing an oval window.

FIG. 5 is a frontal view of a template according to the invention for installing a hexagonal window.

FIG. 6 is a frontal view of a template according to the invention for installing a fan light window.

FIG. 7 is a frontal view of a template according to the invention for installing a triangular window.

FIG. 8A illustrates the use of the template according to the invention to determine the proper cut through wall studs on a wall under construction.

FIG. 8B illustrates the support frame according to the invention inserted into the window opening cut with the aid of the template.

FIG. 9A shows the template temporarily mounted on a wall panel.

FIG. 9B shows the stud-support frame according to the invention inserted into the window opening cut along the outer perimeter of the template.

FIG. 9C shows the finished window fitted into the window opening.

### DETAILED DESCRIPTION OF THE EMBODIMENTS OF THE INVENTION

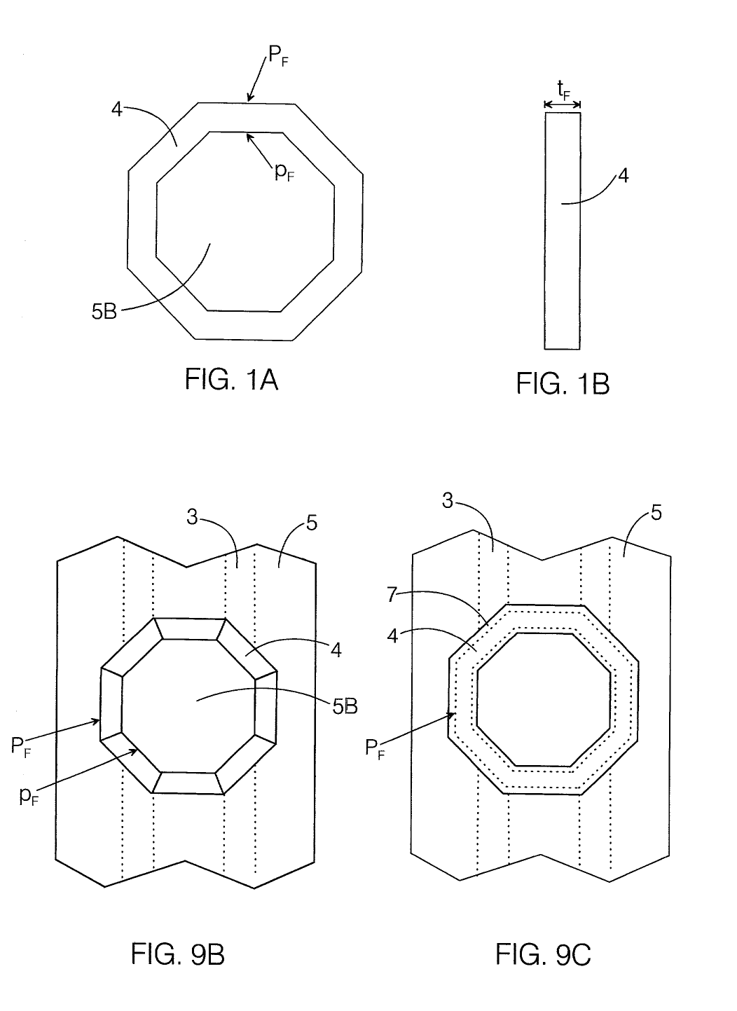

FIGS. 1A, 1B illustrate a stud-support frame 4 according to the invention. The stud-support frame 4 has an outer perimeter P_{F}, and inner perimeter p_{F}, and a thickness t_{F}. Preferably, the stud-support frame 4 is made of an inexpensive and lightweight material that has sufficient strength and rigidity to provide adequate support for wall studs 3 that have been cut through to create a window opening 5A for receiving a prefabricated window. Such materials may include polyurethane or other synthetic material, wood, wood fiber products, and any combination of materials in a composite structure that provides the necessary strength and rigidity as a structural support for the stud construction. For example, a frame made substantially of polyurethane may include a sandwiched layer of a corrugated or honeycombed material of plastic, metal or wood fiber material.

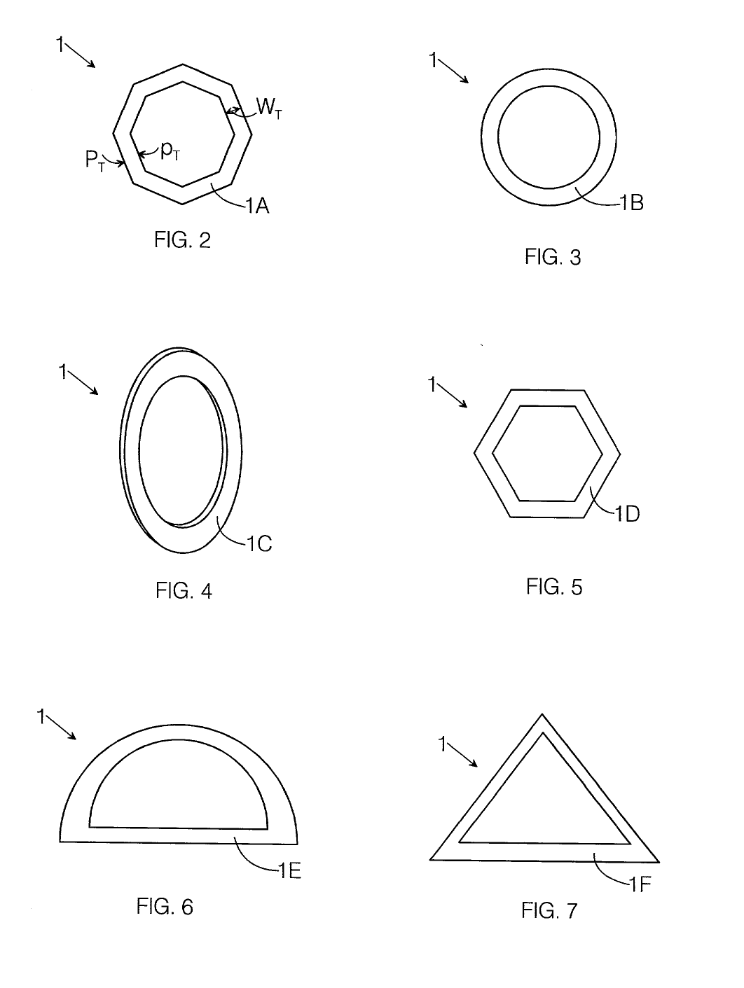

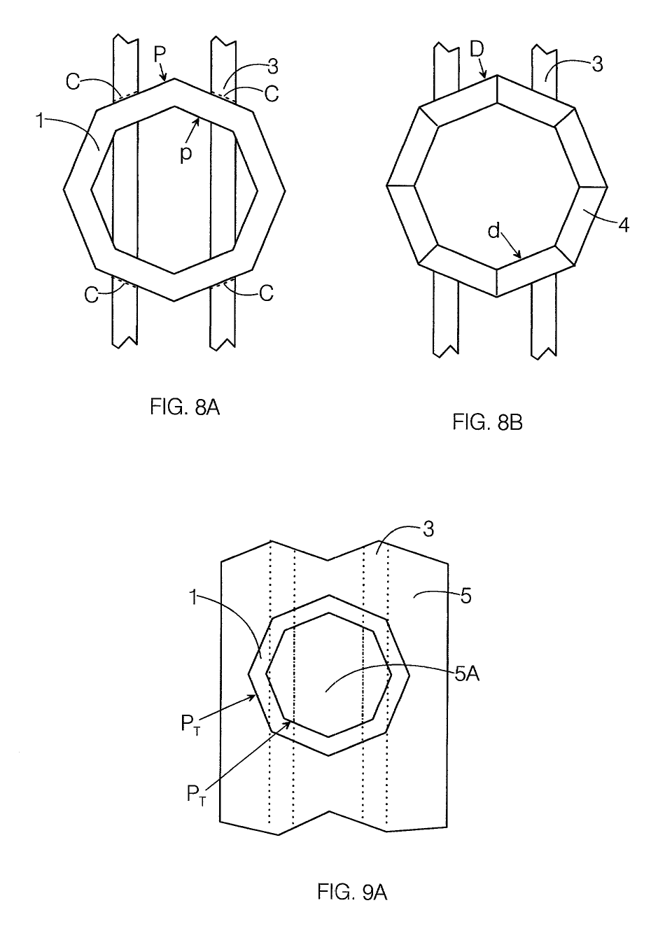

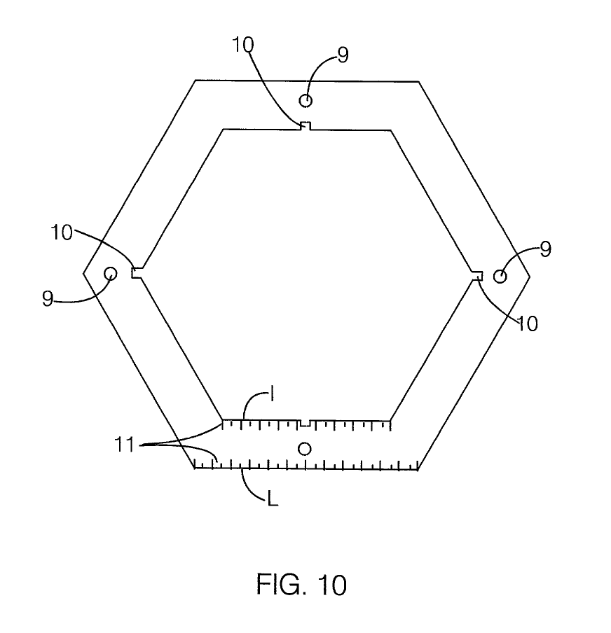

The stud-support frame 4 corresponds in size and shape to a window template 1 of a particular size and shape. FIGS. 2 through 7 each illustrate a particular shape of the template 1, which is a flat piece cut or stamped from sheet metal. The template 1 has an outer perimeter PT and an inner perimeter PT, and a width WT that is the distance between the outer perimeter PF and the inner perimeter PT. The window opening SA is created by securing the template 1 to a wall panel 5 of a stud wall or directly to the studs 3 and cutting through the wall panel 5 and/or studs 3 along the outer perimeter PT of the template 1. Once the window opening 5A is free of obstructions, i.e., studs 3, the stud-support frame 4 is insertable into the window opening 5A, whereby the outer perimeter P_{F} of the stud-support frame 4 is dimensioned relative to the opening 5A such that the frame 4 just fits into the window opening 5A with a small amount of free space to allow for shimming the frame 4 to a level position. The inner perimeter p_{F} of the stud-support frame 4 is dimensioned such that a window casing 9 of the prefabricated window just fits into the stud-support frame 4 with a small amount of free space for shimming the window casing 9 to a level position. Hereinafter, when the term “corresponds” is used to refer to a size and/or shape of the stud-support frame 4 relative to the window template 1, it means that the outer perimeter P_{F} is slightly smaller than the outer perimeter P_{T} of the window template 1 to allow the stud-support frame 4 to fit within the window opening 5A, yet provide a small amount of free space for properly aligning the frame 4 Similarly, a “corresponding” size of the inner perimeter p_{F} of the stud-support frame 4 relative to the outer perimeter of the window casing 9 means that the inner perimeter p_{F} of the stud-support frame 4 is slightly larger than the outer perimeter of the window casing 9 to allow the casing 9 to fit within the stud-support frame 4, as shown in FIGS. 8B and 9B, with sufficient free space to allow for shimming the window casing to maintain proper alignment. Shimming a frame or a window casing to a level position is a common workstep in the process of installing windows and is not shown in any detail herein.

The scope of the present invention encompasses a window installation kit that includes at least one template 1 and at least one stud-support frame 4, whereby the stud-support frame 4 corresponds in size to the template 1. An embodiment of the window installation kit according to the invention also encompasses a set of templates and corresponding stud-support frames, wherein the set of templates includes templates of commonly used or popular sizes and/or shapes. For example, a set of templates 1 and corresponding stud-support frames 4 for octagonal windows includes the typical or commonly used sizes for that shape of window that are available as prefabricated windows. In another embodiment of the installation kit, the set includes a set of templates 1 and stud-support frames 4 of various shapes, each corresponding pair of template 1 and stud-support frame 4 having a particular major dimension.

The method according to the invention is a labor- and time-saving approach to installing windows of non-rectangular shapes, using the stud-support frame 4 and the template 1 as follows: As shown in FIG. 9A, the template 1 is temporarily secured to the wall panel 5 where the window is to be installed. For the sake of illustration, the wall studs 3 located beneath the wall panel 5 are shown with dotted lines. The window opening 5A is cut along the outer perimeter PT of the template 1 and the sections of wall studs 3 shown with dot-dash lines are removed. If the wall is cut-through in sections, for example, if only the outer plywood wall is cut in a first pass around the template 1, some means of transferring location markings from one side of the wall to the other must be applied. The template 1 as disclosed in U.S. patent application Ser. No. 10/012,837 provides template-locator holes or grooves for drilling locator holes from one side of the wall to the other, as a way of simplifying the task of transferring template-locator markings from the plywood side to the drywall side, for example. The template 1 can then be mounted on the drywall side of the wall in a location that corresponds precisely to the location of the template 1 as it was mounted on the plywood wall. After the plywood wall and the drywall have been cut through and the wall sections over the window opening 5A removed, it is then a simple matter to cut and remove the interfering sections of the wall studs 3.

The stud-support frame 4 that corresponds in size and shape to the particular template 1 used to cut the window opening 5A is inserted into the opening 5A to provide a framed window opening 5B, as illustrated in FIG. 9B. The window product is then inserted into the framed window opening 5B and supported by the stud-support frame 4. Next, a finished window trim 7 is assembled around the window product. Preferably. as shown in FIG. 9C, the trim 7 is wide enough to extend beyond the stud-support frame 4, thereby eliminating finish work on the wall around the edge of the trim 7.

The embodiments of the stud-support frame 4 and the window installation kit mentioned herein are merely illustrative of the present invention. It should be understood that variations in construction of the present invention may be contemplated in view of the following claims without straying from the intended scope and field of the invention herein disclosed.

What is claimed is:

1. A stud-support frame for receiving a prefabricated window having a window casing, said stud-support frame having an inner frame perimeter that corresponds substantially in size and shape to an outer perimeter of said window casing so that said window casing is insertable in and supportable by said stud-support frame.

2. The stud-support frame of claim 1, wherein said outer perimeter of said window casing has a non-rectangular shape.

3. The stud-support frame of claim 2, wherein said non-rectangular shape is oval.

4. The stud-support frame of claim 2, wherein said non-rectangular shape is octagonal.

5. The stud-support frame of claim 2, wherein said non-rectangular shape is hexagonal.

6. The stud-support frame of claim 2, wherein said non-rectangular shape is triangular.

7. The stud-support frame of claim 2, wherein said non-rectangular shape is circular.

8. The stud-support frame of claim 2, wherein said non-rectangular shape is semicircular.

9. The stud-support frame of claim 1, wherein said prefabricated window is installable in a stud-wall having an overall wall thickness that includes a thickness of an inner wall panel, a stud, and an outer wall panel, and wherein said stud-support frame has a frame thickness that corresponds substantially to said overall wall thickness.

10. A window installation kit for installing a window having a window casing in a wall having a wall panel and wall studs, wherein a section of said wall studs must be removed to make a window opening for said window, said window installation kit comprising:
said stud-support frame of claim 1 and a template having an outer template perimeter;
wherein said outer frame perimeter corresponds in size and shape to said outer template perimeter such that, when said window opening is formed by cutting along said outer template perimeter through said wall, including through said wall studs, said stud-support frame is insertable into said window opening and attachable to said wall studs so as to provide a framed window opening that provides support for said wall studs, and wherein said window casing is insertable in and is supportable by said stud-support frame.

11. The window installation kit of claim 10, further comprising window trim, wherein said stud-support frame has a frame width and said window trim has a trim width that is wider that said frame width.

12. The window installation kit of claim 10 further comprising a plurality of matched pairs of said template and said stud-support frame.

13. A method of installing a window with window trim in a studded wall construction, said window having a window casing, said method comprising the steps of:
a) cutting a window opening in said studded wall construction, wherein said cutting cuts through an inner wall panel, and outer wall panel, and one or more wall studs;
b) inserting said stud-support frame according to claim 1 in said window opening;
c) fastening said stud-support frame to said one or more wall studs;
d) inserting said window casing in said stud-support frame;
e) assembling said window trim around said window casing on said studded wall construction over a face of said stud-support frame that is on a face of said studded wall construction.

14. The method of claim 13, further comprising the step of first securing a template corresponding in size and shape with that of said stud-support frame to said studded wall construction before the step of cutting said window opening, wherein said step of cutting said window opening includes the step of cutting along an outer perimeter of said template to cut said window opening that corresponds in size and shape to said window to be installed.
